(19) United States
(12) Patent Application Publication
(10) Pub. No.: US 2009/0100875 A1
(43) Pub. Date: Apr. 23, 2009

(54) Sheet glass oven

(75) Inventors: Axel Engels, Romhild (DE); Gerd Hanisch, Romhild (DE)

Correspondence Address: MAYER & WILLIAMS PC, 251 NORTH AVENUE WEST, 2ND FLOOR, WESTFIELD, NJ, 07090, US

(73) Assignee: Eliog-Kelvitherm Industrieofenbau GmbH, Romhild (DE)

(21) Appl. No.: 11/988,886

(22) PCT Filed: Jul. 13, 2006
(86) PCT No.: PCT/EP2006/064186

§ 371 Date: Jan. 15, 2008

(30) Foreign Application Priority Data
Jul. 15, 2005 (DE) 10 2005 033 776.7

(51) Int. Cl. C03B 27/012

(52) U.S. Cl. 65/114; 65/348

(57) ABSTRACT

The invention relates to a sheet glass oven, in particular for tempering glass panes including a lower oven part provided with stove rollers for transporting the temperable glass panes, where the axes of rotation of the oven rollers are arranged substantially in a perpendicular position to the direction of a glass pane extension. The oven also includes a top oven part having a central section and a lid. The oven is also provided with lower heating groups and top heating groups, where the heating groups extend under the oven rollers and the top heating groups extend thereabove and are formed by electric heat resistances. The sheet glass oven includes several air circulation units, which are mounted in the top oven part above the top heating groups and include an air circulating hood and an integrated fan wheel, respectively, where the air circulating hood is provided with exhaust openings, which communicate with the oven lower space in the top section of the top oven part, and several air nozzles are provided which are located on the bottom side of the air circulating hood and are supplied with compressed air by the fan wheel and lead an exit air stream in the direction of a heatable glass pane.

The present invention concerns a sheet glass oven, especially suitable for tempering of glass panes, wherein this oven can be hooked up with familiar sections for shock cooldown and aftercooldown of the glass sheets heated in the oven. Such a sheet glass oven has a lower oven part and an upper oven part. Oven rollers are arranged in the oven to transport the glass sheet which is to be heated. Furthermore, several heating elements are present, which are supposed to provide the most uniform possible heating of the glass sheets.

EP 1 241 143 A2 describes a tempering oven, which is outfitted with heating elements both on the floor and in the upper oven region and with elements for thermal convection in the upper oven part. The glass sheets are transported through the oven via rollers. The thermal convection elements arranged in the lengthwise direction produce different thermal convection zones, which can be altered relative to each other. A direct blowing of convection air onto the glass sheet from above is used to heat the glass sheet. The resulting currents, however, produce a nonuniform heating, especially in the case of large glass sheets, and this can lead to substantial unwanted material stresses.

A roller oven for heating of glass sheets to their softening temperature is known from U.S. Pat. No. 4,529,380. The described roller oven has an arrangement of gas jet pumps, which are arranged above the roller track, transverse to the direction of movement of the glass sheets, for blowing of hot gas onto the top side of the glass sheets, and thereby make possible a heating of these top sides by convection. To heat the lower surface of the glass sheets, heating resistors are used, being arranged underneath the roller track.

What is common to the ovens known from the prior art is that the objective of the most uniform possible heating of the glass sheets brought into the oven is pursued by the arrangement of several heating groups and in part by the combination of different principles of heat transmission. This is necessary in order to achieve good results in the specific formation of material stresses, such as is needed in particular when making single-pane safety glass. Frequently, radiative heating elements are used for this, especially electrical heating resistors and thermal radiators, coupled to convectively operating heating elements, such as hot gas conduits. Besides the uniform heating of the glass sheet, another goal is to shorten the heat-up times, while the temperature gradient within the glass sheet should not become too large, or else the glass may break.

The problem of the present invention is therefore to provide an improved sheet glass oven with which one can ensure short heat-up times and the most uniform possible temperature distributions in the overall oven.

This problem is solved according to the invention by a sheet glass oven in which, besides lower heating groups beneath the oven rollers and upper heating groups above the oven rollers, there are provided several air circulation units in the upper oven part, each consisting of electrical heating resistors, which specifically achieve a convective heating of the glass sheet by blowing the heated oven air onto the top side of the glass from numerous air nozzles. The oven air is moved in the process of circulation and specifically swirled in the air circulation units in order to achieve a very uniform heating. The circulating air flow within the oven makes sure that all regions of the oven are at practically the same temperature level, which cannot be achieved by the arrangement of the electrical heating resistors by themselves. Thanks to the arrangement of several air circulation units, which extend essentially over the entire bearing surface available for the glass sheets, one can select low flow velocities and nevertheless achieve a high uniformity in the temperature distribution.

The sheet glass oven specified here is especially suited for the tempering of glass panes with dimensions of at most 2.00 m×3.40 m and glass thicknesses between 3 and 12 mm. The customary heating temperatures in this oven are around 620 to 680 degrees C.

Preferably, the sheet glass oven is part of a glass tempering line, which furthermore includes layouts for shock cooldown and after-cooldown of the heated glass sheets. The cooldown in this case occurs outside the sheet glass oven and transport stretches are provided between the individual sections of the glass tempering line.

In a preferred embodiment, the sheet glass oven is designed for a temperature rating of 750 degrees C. and a heating power of around 600 kW.

In order to bring large glass sheets into the oven, a charging roller track is normally present, on which the glass sheet to be heated in set down and oriented for the subsequent transport on the oven rollers. For this, if need be, so-called miniroller tracks can be deployed between the individual rollers underneath the lift platform, on which the glass sheet can be shifted transversely to the main direction of transport.

In a preferred embodiment of the sheet glass oven, the air nozzles of each air circulating hood of the air circulation units are arranged in several rows, extending basically perpendicular to the direction of travel of the glass sheet. Such rows of nozzles can be provided simply with uniform air pressure, so that the emergence of air at the nozzles is almost independent of their position within the oven. Of course, other nozzle arrangements can also be chosen if the air conduits inside the air circulating hood make sure that the most uniform possible distribution of the emerging air is achieved.

It is advantageous to deflect the oven air drawn in against one or more baffles inside the air circulating hood in order to achieve a strong swirling of the oven air intake within the air circulation unit. This serves to make the temperature level of the circulating air even more uniform, as it is deflected onto the glass sheet for further heating. It has been found that even small temperature differences at different outlet nozzles lead to stresses within the glass sheet, which can result in glass fracture.

In a preferred embodiment, the fan wheels in the air circulation units are coupled onto speed-regulated motors, which are located outside the oven space. Through the speed regulation, one can influence the flow conditions inside the oven so that, for example, a high flow velocity can be adjusted in the initial phase of a heating, while lower flow velocities are selected at high temperatures.

It is advisable to wind the electrical heating resistors of the upper and lower heating groups onto ceramic threaded pipes, which are preferably stabilized by support pipes. In order to adapt the oven to the desired process conditions, as demanded by glass sheets of different thickness, the upper heating groups can preferably be adjusted to change the distance from the glass sheet. It is also possible to integrate the air circulation units in the respective height adjustment system.

Further benefits, details, and modifications will result from the following description of a preferred embodiment of the invented sheet glass oven. This shows:

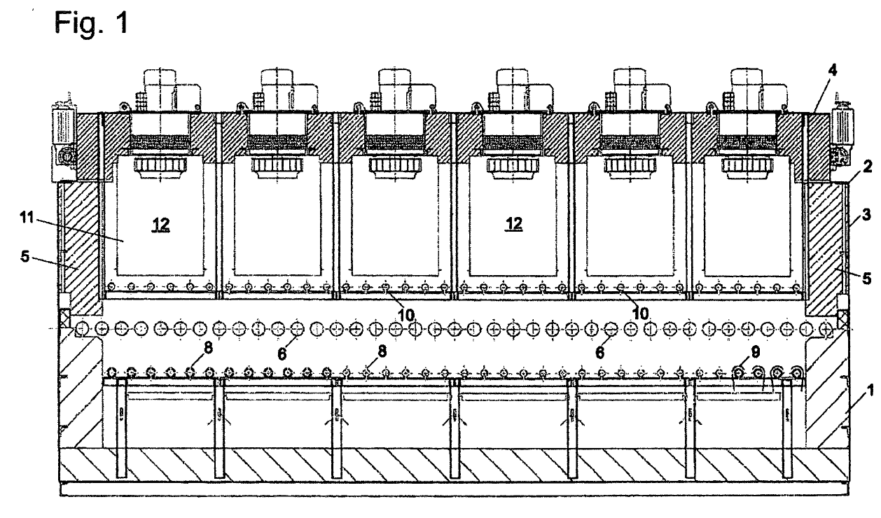

FIG. 1, a sheet glass oven in a longitudinal section view;

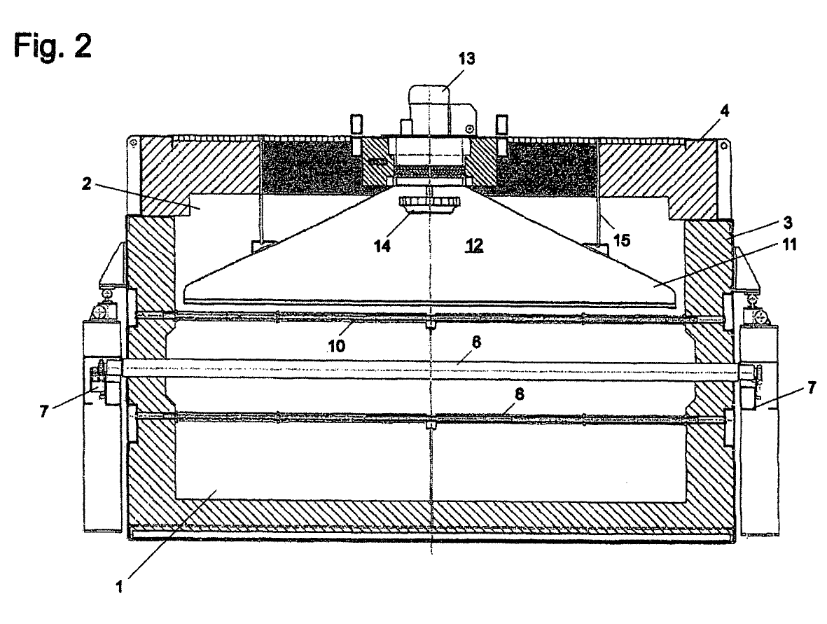

FIG. 2, the sheet glass oven in a cross section view;

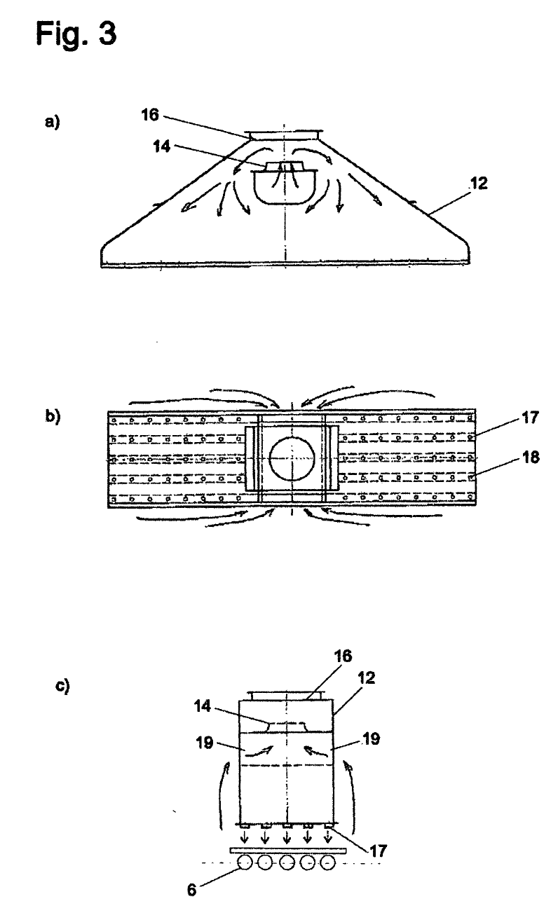

FIG. 3, three views of an air circulating hood of an air circulation unit arranged in the upper oven part.

FIGS. 1 and 2 show in a simplified representation a longitudinal section view and a cross section view of a sheet glass oven according to the invention. The sheet glass oven has a lower oven part 1 and an upper oven part 2 with a middle section 3 and a cover 4. Middle section and cover of the upper oven part can be separated from each other for maintenance purposes. Lift doors 5 are provided at the entrance and exit openings of the middle part 3, which can be moved by corresponding lifting devices.

In the lower oven part 1, a series of oven rollers 6 extends along the entire oven length, with their pivot axes lying transversely to the direction of transport. The oven rollers 6 preferably consist of quartz material and lie with their ends loosely on roller drive frames 7 situated at either side. The oven rollers are driven, for example, by means of a frequency-controlled gear motor and by use of a synchronous belt drive. In order to orient the oven rollers exactly in a transport height, each oven roller 6 can be individually adjustable in height.

Beneath the oven rollers 6 there are provided lower heating groups 8, preferably being formed by electrical heating resistors. It is advisable to configure the lower heating groups so they are separately regulable, in order to promote a uniform temperature distribution in the oven by appropriate actuation of individual heating groups. The electrical heating resistors are preferably wound on ceramic threaded pipes, which in turn are fitted onto a support pipe. The support pipe lies with its ends on the side oven insulation and is further supported on one or more fulcrums in the lengthwise direction when the oven is of rather large size.

In order to protect the heating resistors from falling glass fragments in event of a glass breakage, the lower heating groups 8 are each covered by a protective cover 9, which consists of a perforated, heat-resistant material.

In order to catch any glass breakage, broken glass tubs are arranged underneath the lower heating groups 8. These can be taken out from the oven at the side, in order to remove the accumulated broken glass.

Furthermore, temperature sensors are arranged at several points in the oven, by which the local temperature and furthermore the temperature distribution in the entire oven can be determined with utmost precision. The measured values obtained are used to actuate the individual heating groups, always with the goal of a uniform oven interior temperature.

Above the oven rollers 6, upper heating groups 10 are arranged as parts of the upper oven part 2. Again, these are preferably electrical heating resistors, constructed in comparable manner to the lower heating groups, and they can likewise be actuated by groups or even individually. When the oven space is dimensioned to accommodate glass sheets of around 2 m×3.40 m, it has proven to be advisable to divide the heating groups into 24 upper groups and 24 lower groups.

One can omit the cover for the upper heating groups, since there is no danger of damage from falling pieces of broken glass.

Furthermore, it is advantageous to suspend the upper heating groups from perpendicular ceramic pipes, so that it is possible to adjust the height of the heating groups from the outside.

In the upper oven part 2, moreover, there are arranged several air circulation units 11, which are located above the upper heating groups 10. Each air circulation unit has an air circulating hood 12, whose construction shall be explained more closely in relation to FIG. 3. Each air circulation unit 11 is furthermore coordinated with a speed-regulated motor 13, which drives a fan wheel 14. In the depicted embodiment, there are 6 air circulation units 11 provided one after the other in the lengthwise direction, in order to achieve a uniform flow in the entire oven interior space to provide minimal temperature gradients.

It can also be seen from FIG. 2 that each air circulating hood 12 can be fastened by a hanger 15 from the cover 4. In this way, it is possible to adjust the position of the air circulating hoods in order to adapt it to the fan wheels and motors being used.

FIG. 3 shows in three simplified views a preferred embodiment of the air circulating hood 12, with arrows showing the direction of flow during the circulating operation. From the front view of the air circulating hood shown in Fig. a) one can see that the heated air drawn in from the oven interior by the fan wheel 14 inside the air circulating hood is at first blown upward, where it makes contact with a baffle 16 and is swirled. The accelerated air currents then flow back down, guided by the configuration of the air circulating hood 12. The air circulating hood preferably has the shape of a truncated cone with a rectangular base surface, on which several rows 18 of air nozzles 17 are arranged, as can be seen from the top view shown in figure b).

The air currents produced by the air circulation units can be easily recognized from the side view per figure c) of FIG. 3. The air present in the oven space is sucked into the air circulating hood through intake openings 19 arranged in the upper region of the air circulating hood 12. After this, swirling and pressurization of the flow occurs by means of the fan wheel 14. The swirled air is blown out at the lower end of the air circulating hood through the air nozzles 17. The emerging air is aimed at the glass sheet, resting on the oven rollers 6.

Although not shown in figure c) of FIG. 3, before making contact with the glass sheet the air emerging from the air nozzles 17 flows through the upper heating groups 10, which extend between the over rollers 6 and the air circulation units 11 (see FIG. 2). A further heating of the air flow occurs in this place. Moreover, stagnant air around the upper heating group 10 is prevented, which can further shorten the heat-up times.

Air baffles can be arranged inside the air circulating hood 12, which vary the flow cross section of individual air conduits, taking into consideration the length of the conduits. One objective of this is to distribute as evenly as possible the exit velocity and the air quantity at the air nozzles 17.

In modified embodiments, it is conceivable to arrange additional air circulation units in the lower oven part, in order to apply a deliberate air flow to the bottom side of the glass sheet being heated. In this way, it is possible to further increase the uniformity of the temperature distribution in the glass sheet and the convection component is increased at the desired thermal transition.

### LIST OF REFERENCE NUMBERS

1 lower oven part

2 upper oven part

3 middle section 3

4 cover

5 lift doors

6 oven rollers

7 roller drive frames

8 lower heating groups

9 protective cover

10 upper heating groups

11 air circulation unit

12 air circulating hood

13 motor

14 fan wheel

15 hanger

16 baffle

17 air nozzles

18 rows of nozzles

19 intake opening

1. A sheet glass oven for tempering of glass panes, comprising:
an oven lower part with oven rollers for the transport of the glass sheet being tempered, wherein the pivot axes of the oven rollers lie substantially perpendicular to the direction of travel of the glass sheet;
an oven upper part with a middle section and a cover;
a plurality of lower heating groups, which extend beneath the oven rollers and are formed by electrical heating resistors;
a plurality of upper heating groups, which extend above the oven rollers and are formed by electrical heating resistors;
several air circulation units, which are arranged in the oven upper part above the upper heating groups, each including an air circulating hood with an enclosed fan wheel, wherein the air circulating hood has the shape of a truncated pyramid with a rectangular base surface and at least one intake opening, the intake opening being positioned such that oven air drawn in from the oven interior space by the fan wheel is blown upward in the direction of a baffle and from there the oven air is swirled and caused to flow downward, and wherein several air nozzles are arranged in a plane of the rectangular base surface of the truncated-pyramid of the air circulating hood, the air nozzles being supplied with compressed air from the fan wheel and serving to deflect the emerging air flow in the direction of the glass sheet being heated.

2. The sheet glass oven of claim 1, wherein the air nozzles of the air circulating hood are arranged in several rows, extending substantially perpendicular to the direction of travel of the glass sheet at the bottom side of the air circulating hood.

3. The sheet glass oven of claim 1, wherein the fan wheel in the air circulating hood is driven by a speed-regulated motor coordinated with the air circulation unit, the same being arranged outside the oven space on the cover of the oven.

4. The sheet glass oven of claim 1, wherein the air outlet surfaces of the air circulation units in which the air nozzles lie overlap substantially the entire bearing surface which can be occupied by the glass sheet being tempered in the oven.

5. The sheet glass oven of claim 1, wherein the cover of the oven upper part is removably fastened to the middle section.

6. The sheet glass oven of claim 1, wherein the electrical heating resistors of the upper and lower heating groups are wound onto ceramic threaded pipes.

7. The sheet glass oven of claim 6, wherein the ceramic threaded pipes of the upper and lower heating groups are fitted onto support pipes, which extend transversely to the direction of travel of the glass sheet.

8. The sheet glass oven of claim 6, wherein the ceramic threaded pipes of the lower heating groups are covered by a removable, perforated protective cover made of heat-resistant material.

9. The sheet glass oven of claim 6, wherein the ceramic threaded pipes of the upper heating groups are arranged at a variable distance from the transport plane of the glass sheet.

10. The sheet glass oven of claim 1, wherein the oven forms part of a glass tempering line, which further includes a section for shock cool down and a section for after cool down.

11. A method of tempering panes of sheet glass, comprising:
moving a pane of glass into an oven, the oven including:
an oven lower part with oven rollers for the transport of the pane of glass, wherein the pivot axes of the oven rollers lie substantially perpendicular to the direction of travel of the glass sheet;
an oven upper part with a middle section and a cover;
a plurality of lower heating groups, which extend beneath the oven rollers and are formed by electrical heating resistors;
a plurality of upper heating groups, which extend above the oven rollers and are formed by electrical heating resistors;
at least one air circulation unit, which is arranged in the oven upper part, above the upper heating groups, the air circulation unit including an air circulating hood with an enclosed fan wheel, wherein the air circulating hood has the shape of a truncated pyramid with a rectangular base surface and at least one intake opening;
drawing oven air from the oven interior space by the fan wheel such that the oven air is blown upward in the direction of a baffle and from there it is swirled and caused to flow downward;
supplying several air nozzles arranged in the plane of the base surface of the truncated pyramid of the air circulating hood with compressed air from the fan wheel; and
deflecting the emerging air flow in the direction of the pane of glass being tempered.
